(19) United States
(12) Patent Application Publication
(10) Pub. No.: US 2006/0119867 A1
(43) Pub. Date: Jun. 8, 2006

(54) Thickness measuring method for organic coating film on metal surface

(75) Inventors: Hee Sung Choi, Koyang (KR); Hyo Soo Lee, Daejeon (KR); Jin Young Kim, Seoul (KR); Hui Jin Lee, Yongin (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Samsung Electro-Mechanics Co., Ltd., Suwon (KR)

(21) Appl. No.: 11/292,141

(22) Filed: Dec. 1, 2005

(30) Foreign Application Priority Data
Dec. 7, 2004 (KR) 10-2004-102610

(51) Int. Cl. B05D 5/12; G01B 11/06

(52) U.S. Cl. 356/632; 427/8; 427/96.1

(57) ABSTRACT

The invention relates to a thickness-measuring method for an organic coating film such as an organic solderability preservative film formed on a metal film. In the method, an absorption spectrum of at least one reference organic coating film formed on a first metal surface is measured and absorption intensity in a predetermined wavelength range is calculated from the absorption spectrum. The thickness of the reference organic coating film is measured by destructive measurement. Then, correlation is defined based upon the absorption intensity and measured thickness of the reference organic coating film. An absorption spectrum of an organic coating film to be measured. Absorption intensity in the predetermined wavelength range is calculated from the absorption spectrum of the organic coating film to be measured, and the thickness of the organic coating film is calculated from the absorption intensity thereof based upon the correlation.

### RELATED APPLICATION

The present application is based on and claims priority from Korean Application Number 2004-102610, filed Dec. 7, 2004, the disclosure of which is hereby incorporated by reference herein in its entirety.

### BACKGROUND OF THE INVENTION

1. Field of the Invention

The present invention relates to a thickness-measuring method for an organic coating film, and more particularly, for a sub-micron size organic solderability preservative film formed on a metal pad such as a copper pad having a relatively large surface roughness.

2. Description of the Related Art

The thickness of a coating film is measured generally according to destructive and nondestructive techniques. The coating film loses its function in the destructive analysis, but maintains its function in the nondestructive technique. The destructive technique causes physical/chemical destruction to the coating film to such a degree that the coating film can be hardly restored. Besides, the destructive measurement is carried out merely in a restricted area, and thus can hardly represent properties across the coating film.

On the contrary, the nondestructive technique such as Infrared Ray (IF) analysis is accepted available for analyzing thickness as well as composition. The nondestructive technique has advantages in that the coating film can maintain its function and prompt analysis can be obtained.

Notwithstanding these advantages, the nondestructive technique is not properly used as a thickness-measuring method for an organic coating film formed on a metal surface such as an Organic Solderability Preservative (OSP) film formed on a copper surface. This comes from rather irregular thickness of an organic coating film formed on a relatively rough metal surface, which obstructs standardization.

In particular, standardization becomes more difficult in case of an OSP film formed on an etched copper pattern. So, the thickness of the OSP film has been measured by the nondestructive, indirect measuring technique up to date as will be described with reference to FIGS. 1a and 1b and FIG. 2.

FIG. 1a shows a chip-scale package 10 to which an OSP film can be applied. As shown in FIG. 1a, and an etched copper pattern 16 is formed on the underside of a substrate 12 on which a chip 14 is mounted, and connected to the chip 14 via an internal circuit (not shown). An OSP film 18 is coated on the copper pattern 16 to improve solderability. It is important to form the OSP film 18 at a suitable thickness of sub-micron size in view of electrical reliability and solderability.

However, since the OSP film 18 is formed on the rough surface of the copper pattern 16 as shown in FIG. 1b (exaggerating A part in FIG. 1a), it is difficult to measure the thickness of the OSP film 18 by nondestructive measurement such as spectroscopy.

Accordingly, OSP film thickness has conventionally been measured by indirect, destructive analysis as shown in FIG. 2.

Referring to FIG. 2, an OSP film, the thickness of which is to be measured, is formed on a substrate according to a specific process (e.g., process time) in S21. In this case, the substrate to be used for thickness-measurement has a predetermined area of copper pattern formed thereon, with surface roughness equal to that of the copper film in FIG. 1a as used in practice. Then, the OSP film is fully solved by hydrochloric acid solution, producing organic solution in S23, and ultraviolet spectroscopy is conducted on the organic solution to measure the concentration of SOP material in S25. Then, OSP film thickness is calculated based upon the measured concentration (the quantity of OSP material) and the OSP film area in S27. Based upon the OSP film thickness produced under such specific process condition, estimation is made on the thickness of an OSP film on products manufactured in practice under the same process condition in S29.

However, the foregoing thickness-measuring method is merely an indirect measuring technique carried out with poor reliability under specific process condition. Furthermore, this thickness-measuring method is complicated since respective process conditions require different thickness data.

### SUMMARY OF THE INVENTION

The present invention has been made to solve the foregoing problems of the prior art and it is therefore an object of the present invention to provide a thickness-measuring method for an organic coating film, and more particularly, for a sub-micron size organic solderability preservative film formed on a metal pad such as a copper pad having a relatively large surface roughness.

In order to realize the foregoing object, the present invention provides a thickness-measuring method for an organic coating film, the method comprising steps of: measuring an absorption spectrum of at least one reference organic coating film formed on a first metal surface; calculating absorption intensity in a predetermined wavelength range from the absorption spectrum of the organic coating film; measuring the thickness of the reference organic coating film by destructive measurement; defining correlation between absorption intensity and film thickness based upon the absorption intensity and measured thickness of the reference organic coating film; measuring an absorption spectrum of an organic coating film to be measured, formed on a second metal surface; calculating absorption intensity in the predetermined wavelength range from the absorption spectrum of the organic coating film to be measured; and calculating the thickness of the organic coating film to be measured from the absorption intensity thereof based upon the correlation between absorption intensity and film thickness.

The organic coating film to be measured can be advantageously applied to a metal surface having a high surface roughness owing to etching, in which the reference organic coating film and the organic coating film to be measured are made of metal, imparted with surface roughness under an equal etching condition.

Preferably, the reference organic coating film may be an organic solderabilty preservative film, and wherein the organic coating film to be measured may be an organic solderabilty preservative film formed on a copper pattern of a printed circuit board.

Preferably, the reference organic coating film may comprise a plurality of reference organic coating films, which contain organic materials, preferably, coated on unit surface area with different quantity.

Preferably, the absorption spectrum may be measure by infrared ray spectroscopy, and the predetermined wavelength range may correspond to an absorption peak range of a major ingredient of the reference organic coating film.

In a specific embodiment of the invention, the step of measuring the thickness of the reference organic coating film by destructive measurement may comprise: solving the reference organic coating film on the first metal surface; analyzing the concentration of organic material in the solution; and calculating the thickness of the reference organic coating film based upon the analyzed concentration, in which the step of analyzing the concentration of organic material in the solution may be carried out by infrared spectroscopy.

In another specific embodiment of the invention, the thickness-measuring method may further comprise: forming a standard material film of a uniform thickness on a high-polished wafer; measuring an absorption spectrum of the standard material film; calculating absorption intensity in the predetermined wavelength range from the absorption spectrum of the standard material film; and calculating the ratio between the absorption intensity of the standard material film and the absorption intensity of the organic coating film, wherein the step of defining correlation between absorption intensity and film thickness defines the correlation between the ratio of the absorption intensity and the film thickness, and wherein the step of calculating the thickness of the organic coating film to be measured from the absorption intensity thereof calculates the thickness of the organic coating film based upon the ratio between the absorption intensity of the standard material film and the absorption intensity of the organic coating film to be measured.

By measuring the thickness of an organic coating film based upon thickness variation owing to metal surface roughness by using a standard material film formed on a smooth surface, any errors caused by external influence can be decreased effectively.

In this case, the wafer may be a silicon wafer, the standard material may be perylene, and the step of measuring an absorption spectrum of the standard material film may be carried out infrared ray spectroscopy.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a cross-sectional view illustrating a general chip-scale package;

FIG. 1b is a cross-sectional view illustrating a pad surface of a substrate of the chip-scale package shown in FIG. 1a;

FIG. 2 is a flowchart illustrating a conventional thickness-measuring method for an OSP film;

FIGS. 3a and 3b are a flowchart illustrating a thickness-measuring method for an organic coating film of the invention;

FIG. 4 is a flowchart illustrating a thickness-measuring method for an organic coating film according to a preferred embodiment of the invention;

FIG. 5 is a schematic diagram illustrating an IR spectrometer system that can be used in the invention;

FIG. 6a is a graph illustrating IR absorption spectrum of a reference organic coating film of the invention;

FIG. 6b is a graph illustrating correlation between IR absorption intensity and thickness of the reference organic coating film of the invention;

FIG. 7a is a graph illustrating an IR absorption spectrum of a standard material film (e.g., of perylene) of the invention;

FIG. 7b is a graph illustrating correlation between IR absorption intensity ratio of reference organic coating and standard material films and reference organic coating film thickness of the invention; and

FIG. 8 is a graph illustrating FIB analysis evaluation on an OSP film of the invention.

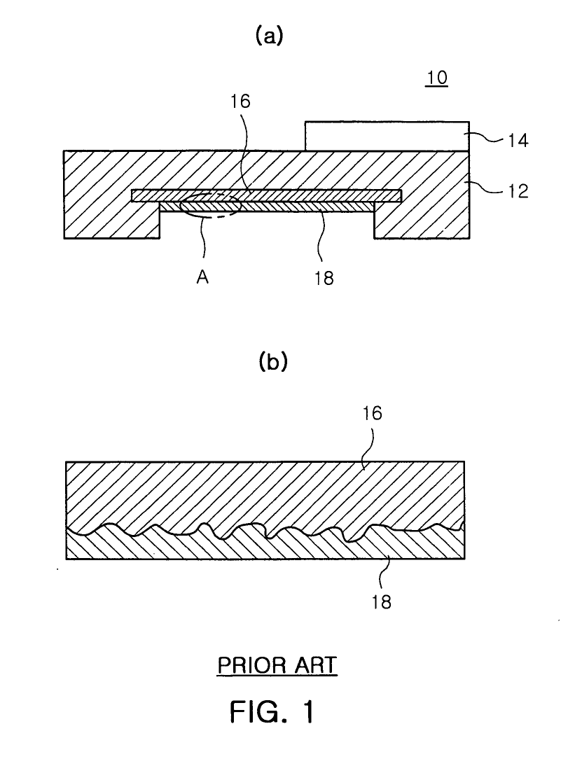

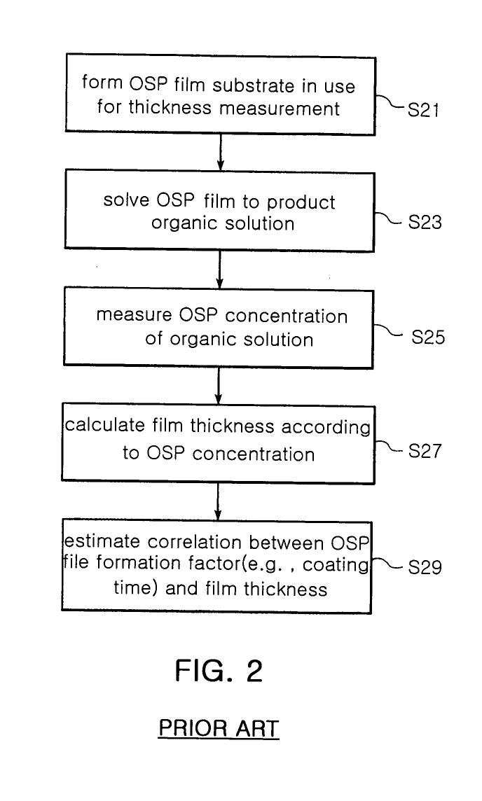

### DETAILED DESCRIPTION OF THE PREFERRED EMBODIMENT

The present invention will now be described in detail with reference to the accompanying drawings.

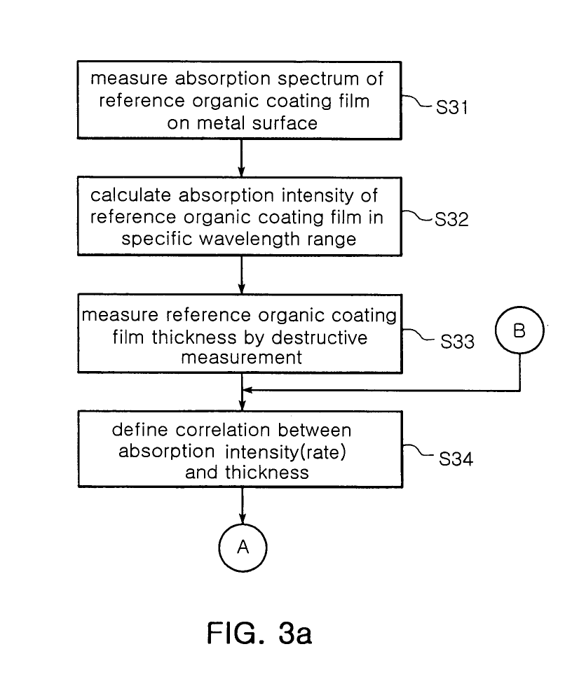

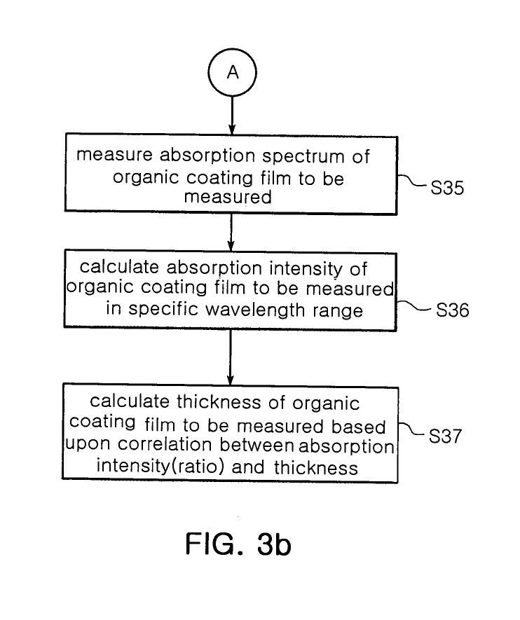

FIGS. 3a and 3b are a flowchart illustrating a thickness-measuring method for an organic coating film of the invention.

The thickness-measuring method for an organic coating film of the invention can be subdivided into a process of calculating the correlation between absorption intensity and thickness by using a reference organic coating film (FIG. 3a) and a process of measuring the thickness of the organic coating film based upon calculated correlation (FIG. 3b).

First, as seen in FIG. 3a, the thickness-measuring method of the invention starts with measuring the absorption spectrum of a reference organic coating film on a reference metal surface in S31. Herein, the reference metal surface with the reference organic coating film formed thereon is a substrate having a predetermined metal surface area. The metal surface is under the same condition as a metal surface on which an organic coating film to be measured actually is formed. Where an organic coating film to be measured actually is an OSP film formed on an etched copper surface, it is preferable that the reference metal surface is surface-roughened under the same etching condition as the etched copper surface. Spectroscopy used for measuring absorption spectrum includes but not limited to IR spectroscopy.

Then, absorption intensity in a specific wavelength range is calculated from the measured absorption spectrum of the reference organic coating film in S32. The wavelength range where the absorption intensity is measured is preferably selected from a range including absorption peak corresponding to the major component of the reference organic coating film. For example, in thickness measurement of an OSP film, preferable wavelength range is about 1230 to 1290 cm⁻¹ corresponding to CH₃⁻ radical.

After the absorption intensity is calculated, the thickness of the reference organic coating film is measured by typical destructive measurement in S33. In this step, the reference organic coating film on the metal surface is solved, and then the concentration of organic material in the solution is analyzed, such that the thickness of the organic coating film can be calculated based upon the analyzed concentration. That is, when an organic material is coated on a known surface area, and its volume is calculated from analyzed concentration, the thickness of the organic material can be measured based upon the surface area and volume thereof. In this case, the concentration of the organic material can be analyzed by IR spectroscopy.

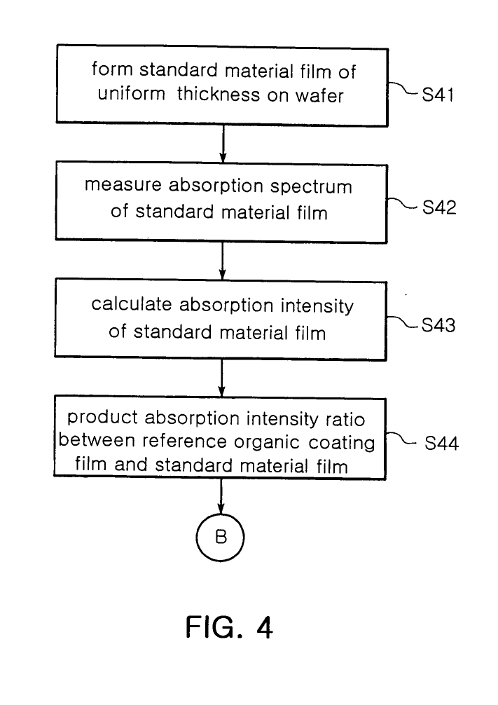

In S34, the correlation between the absorption intensity and thickness of the reference organic coating film is calculated. The absorption intensity includes thickness information, and is substantially proportion to thickness dimension. The correlation between the absorption intensity and thickness of the calculated reference organic coating film can be used to convert the absorption intensity of an organic coating film to be measured actually into thickness. In case of a preferred embodiment, it is possible to obtain absorption intensity ratio with respect to another standard material film formed on a smooth substrate, and then calculate the correlation between absorption intensity ratio and thickness in order to realize more precise thickness measurement. This will be described later with reference to FIG. 4.

The calculation process for the correlation between the absorption intensity and thickness of the reference organic coating film as described above with reference to FIG. 3a can be carried out on a plurality of coating films in order to raise precision higher. In this case, it is preferable that organic material is applied with different quantity onto unit surface areas so that reference organic coating films have different thickness.

Based upon the correlation between the absorption intensity and the thickness calculated as above, the process for measuring the thickness of an organic coating film to be measured is carried out as seen in FIG. 3b.

First, in S35, absorption spectrum measurement is carried out on the organic coating film to be measured. Preferably, this spectrum measurement is carried out by IR spectroscopy in the same fashion as on the reference organic coating film. The organic coating film to be measured actually may be an OSP film of sub-micron size, formed on a copper surface that is for example a pad of a printed circuit board.

Then, absorption intensity in a specific wavelength range is calculated from the absorption spectrum of the organic coating film to be measured in S36. The specific wavelength range where the absorption intensity is calculated is identical with the wavelength range where the absorption intensity of the reference organic coating film is calculated. For example, in thickness measurement of the OSP film, the specific wavelength range is preferably about 1230 to 1290 cm⁻¹ corresponding to Ch₃⁻ radical.

Finally, in S37, the thickness of the organic coating film to be measured is calculated from its absorption intensity based upon the correlation of the absorption intensity and thickness of the reference organic coating film. Since the method of the method directly measures the organic coating film of the same material based upon the correlation of absorption intensity and thickness as described above, it is not required to form the reference organic coating film in the same process as the organic coating film to be measured.

Further, since organic coating films to be measured actually may be distributed across various areas instead of being limited to a specific area, direct measurement was impossible in conventional destructive measurement. So, estimation has been made based upon a result obtained by measuring the thickness of an organic coating film formed on a separate substrate. However, the invention provides an available method capable of directly measuring the thickness of organic coating films formed in various areas of different shape and size.

The measuring method of the invention may additionally adopt an absorption intensity calibration process by using a standard material film as seen in FIG. 4. Absorption intensity ratio calculated from the process in FIG. 4 can be used as means for more precisely measuring the thickness of an organic coating film to be measured in the measuring method as described in FIGS. 3a and 3b. Hereinafter this process will be described in connection with FIGS. 3a and 3b.

First, referring to FIG. 4, the absorption intensity calibration process starts with forming a standard material film of a uniform thickness on a wafer in S41. The wafer may have a smooth surface high-polished into a remarkably low surface roughness unlike the coarse metal surface used in FIGS. 3a and 3b. The standard material film may be made of a different material from the organic coating film, and may preferably adopt any material such as perylene that can be coated to a uniform thickness.

In S42, absorption spectrum measurement is carried out on the standard material film. IR spectroscopy may be used as in the absorption spectrum measurement afore-described in FIGS. 3a and 3b. Then, absorption intensity of the standard material film in a specific wavelength range is calculated in S43. Since different materials are used, the specific wavelength range of the standard material film may be different from the wavelength range in FIGS. 3a and 3b.

In S44, the ratio between the calculated absorption intensity of the standard material film and the absorption intensity calculated in step S32 of FIG. 3a is calculated. In S37 of FIG. 3b, the correlation between the absorption intensity ratio and the thickness is calculated. Then, in S37 of FIG. 3b, the absorption intensity ratio between the organic coating film to be measured and the standard material film is produced so that more precise film thickness can be calculated based upon the correlation calculated in the foregoing step of FIG. 3a.

By using the ratio between the absorption intensity of the standard material film, which is formed at a uniform thickness on the smooth wafer (having a very small surface roughness), and the absorption intensity of the reference organic coating film, it is possible to more precisely measure the thickness of the organic coating film to be measured formed on a rough surface as well as calibrate any influence of disturbance during absorption spectrum measurement by IR radiation.

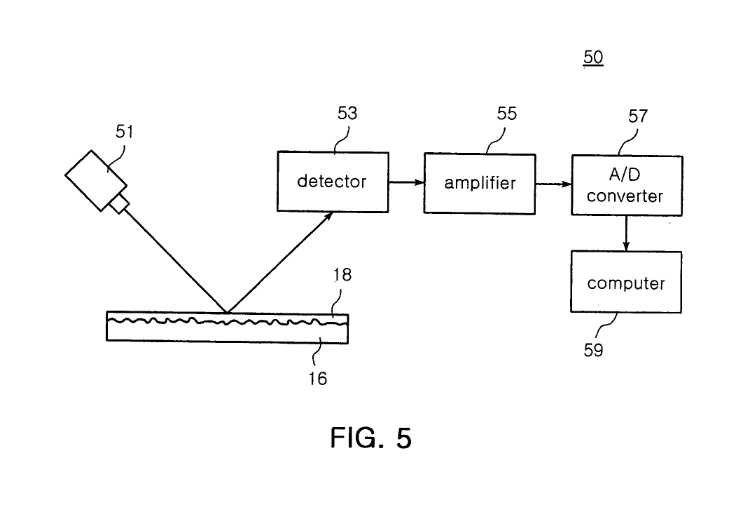

FIG. 5 is a schematic diagram illustrating an IR spectrometer system 50 adoptable by the invention.

As shown in FIG. 5, the IR spectrometer system 50 includes an IR source 51 for emitting IR radiation onto an organic coating film 18 formed on a metal substrate 16. The organic coating film 18 partially absorbs the IR radiation emitted from the IR source 51 while reflecting the remainder of the IR radiation to a detector 53. An IR signal detected by the detector 53 is amplified by an amplifier 55, and then transmitted to a computer 59 via an A/D converter 57. The computer 59 serves to plot an IF spectrum graph according to FR-IR spectroscopy, and may be stored with correlation data between absorption intensity and thickness (as described above with reference to FIGS. 3a and 3b and FIG. 4) as well as programs for providing thickness information of the organic coating film 18 to be measured from absorption spectrum.

The present invention will now be described in more detail through examples.

### EXAMPLE 1

Four (4) copper laminated plates of 10 cm² were prepared as substrates in use for thickness measurement. The copper surface of the laminated plates was cleaned, and then etched under the same condition as for common copper pads. Alkil-benzene-imidazole water solution was applied onto the surface of the 4 copper laminated plates for different time periods, and then moisture was cleared from the copper laminated plates to prepare four reference organic coating films A to D.

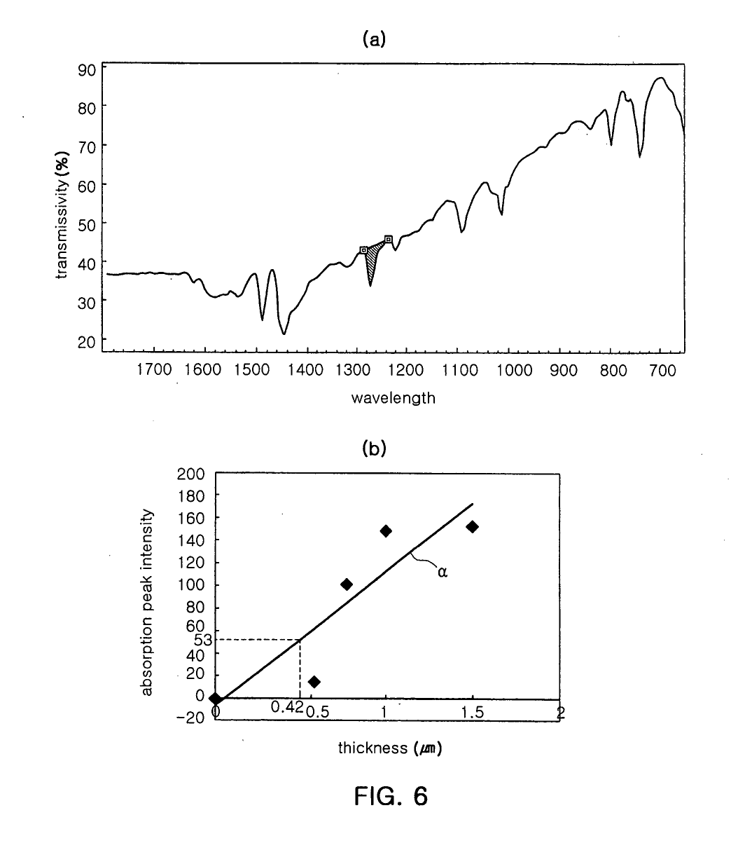

IR absorption spectrum was measured from the four reference organic coating films according to FT-IR technique. Absorption intensity in the range of 1230 to 1290 cm⁻¹ was calculated by integration from the measured IR absorption spectrum. The organic coating films showed absorption intensity values of 15, 99.5, 153 and 160. FIG. 6a is a graph showing an IR absorption spectrum on a reference organic coating film D.

Then, each of the organic coating films was put into a 100 ml beaker, 0.5% hydrochloric acid solution was added by 25 ml into the beaker, the beaker was shaken for 3 to 5 minutes to completely solve the OSP film into organic solution, and then, each organic solution was put into a quartz glass cell. With an IR spectrometer, maximum absorption intensity of 269 to 279 nm was measured symmetrically about 0.5% hydrochloric acid solution. By using the absorption intensity and the surface area of the copper film, each film thickness was calculated. As a result, the organic coating films were measured with thickness of 0.5 μm, 0.7 μm, 1.0 μm and 1.5 μm, respectively.

Then, the correlation between the thickness and absorption intensity of the respective organic coating films was calculated, and their results are reported by a graph in FIG. 6b. The correlation between the thickness and the absorption intensity correlation α may be marked with a solid line.

Then, IR spectrum was measured from an OSP film of unknown thickness made of the same material as the organic coating films. At the same wavelength range, its absorption intensity was 53. Based upon the correlation α above, the thickness of the OSP film was calculated about 0.42 μm.

### EXAMPLE 2

Example 2 was applied to the thickness-measuring method of the invention by converting the correlation between the absorption intensity and thickness of the reference organic coating film obtained from Example 1 into more precise correlation between absorption intensity ratio and thickness based upon absorption intensity information of an external standard material.

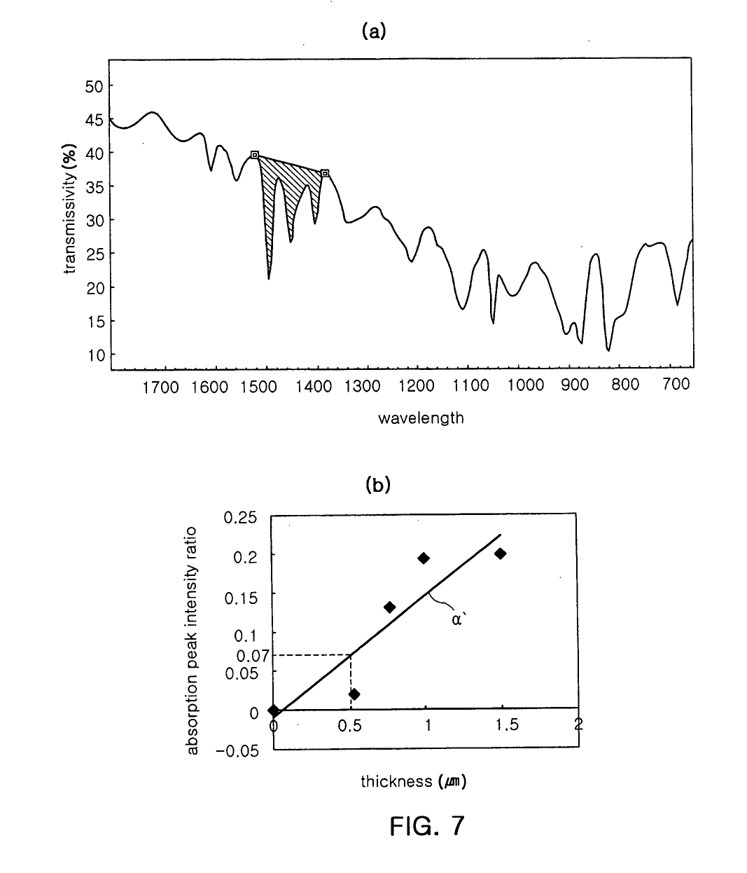

First, perylene was coated at a thickness of 1.2 μm on a high-polished Si wafer, and absorption spectrum measurement was conducted by IR spectroscopy. The measured spectrum is plotted in FIG. 7a. Absorption intensity in a wavelength range of 1380 to 1520 cm⁻¹ was measured, and the absorption intensity of the reference organic coating film measured in Example 1 was divided by the absorption intensity of perylene (of about 765) to produce absorption intensity ratios. Absorption intensity ratios related with the organic coating films were 0.02, 0.13, 0.2 and 0.21. The absorption intensity-thickness correlation α′ was plotted in graph of FIG. 7b. In Example 2, the absorption intensity-thickness correlation α′ plotted in FIG. 7b graph can be expressed according to Equation 1 below:

Film thickness (μm)={(absorption intensity of OSP film)/(absorption intensity of perylene)+0.0085}/0.1542 Equation 1

In Example 2, when the absorption intensity of an OSP film, the thickness of which is not known, was 53 according to Equation 1 as in Example 1, the thickness of the OSP film was calculated about 0.5 μm.

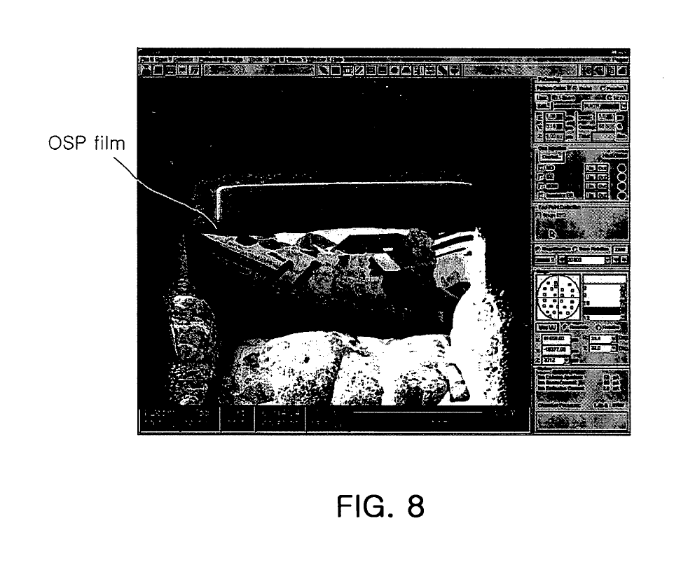

In order to examine the precision of the measurement result, the thickness of the OSP film was measured according to one of destructive measurements such as FIB analysis. FIG. 8 shows thickness evaluation result of an OSP film measured according to FIB analysis. The OSP film had a thickness of about 0.4 to 0.7 μm, showing that the result of Example 2 is very precise, approximate to the mean value. The result of Example 1 also corresponded to the evaluation range of FIB analysis.

As described hereinbefore, the present invention provides a measuring method that can produce the correlation between the absorption intensity and thickness of a reference organic coating film, and based upon the correlation, directly measure the thickness of an organic coating film to be measured actually by nondestructive technique. Compared to indirect, destructive measurement of the prior art, the measuring method of the invention directly measures the thickness of an organic coating film to be measured while maintaining the function of the organic coating film, and thus can be positively used as a technique standardizing the thickness measurement of organic coating films.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

What is claimed is:

1. A thickness-measuring method for an organic coating film, the method comprising steps of:
measuring an absorption spectrum of at least one reference organic coating film formed on a first metal surface;
calculating absorption intensity in a predetermined wavelength range from the absorption spectrum of the organic coating film;
measuring the thickness of the reference organic coating film by destructive measurement;
defining correlation between absorption intensity and film thickness based upon the absorption intensity and measured thickness of the reference organic coating film;
measuring an absorption spectrum of an organic coating film to be measured, formed on a second metal surface;
calculating absorption intensity in the predetermined wavelength range from the absorption spectrum of the organic coating film to be measured; and
calculating the thickness of the organic coating film to be measured from the absorption intensity thereof based upon the correlation between absorption intensity and film thickness.

2. The thickness-measuring method according to claim 1, wherein the reference organic coating film and the organic coating film to be measured are made of metal, imparted with surface roughness under an equal etching condition.

3. The thickness-measuring method according to claim 1, wherein the reference organic coating film is an organic solderabilty preservative film, and
wherein the organic coating film to be measured is an organic solderabilty preservative film formed on a copper pattern of a printed circuit board.

4. The thickness-measuring method according to claim 1, wherein the reference organic coating film comprises a plurality of reference organic coating films, which contain organic materials coated on unit surface area with different quantity.

5. The thickness-measuring method according to claim 1, wherein the absorption spectrum is measured by infrared ray spectroscopy.

6. The thickness-measuring method according to claim 1, wherein the predetermined wavelength range corresponds to an absorption peak range of a major ingredient of the reference organic coating film.

7. The thickness-measuring method according to claim 1, wherein the step of measuring the thickness of the reference organic coating film by destructive measurement comprises:
solving the reference organic coating film on the first metal surface;
analyzing the concentration of organic material in the solution; and
calculating the thickness of the reference organic coating film based upon the analyzed concentration.

8. The thickness-measuring method according to claim 7, wherein the step of analyzing the concentration of organic material in the solution is carried out by infrared spectroscopy.

9. The thickness-measuring method according to claim 1, further comprising:
forming a standard material film of a uniform thickness on a high-polished wafer;
measuring an absorption spectrum of the standard material film;
calculating absorption intensity in the predetermined wavelength range from the absorption spectrum of the standard material film; and
calculating the ratio between the absorption intensity of the standard material film and the absorption intensity of the organic coating film,
wherein the step of defining correlation between absorption intensity and film thickness defines the correlation between the ratio of the absorption intensity and the film thickness, and
wherein the step of calculating the thickness of the organic coating film to be measured from the absorption intensity thereof calculates the thickness of the organic coating film based upon the ratio between the absorption intensity of the standard material film and the absorption intensity of the organic coating film to be measured.

10. The thickness-measuring method according to claim 9, wherein the wafer is a silicon wafer, and the standard material is perylene.

11. The thickness-measuring method according to claim 10, wherein the correlation between absorption intensity and film thickness is defined by eqaution below:
film thickness (μm)={(absorption intensity of an organic solderabilty preservative film)/(absorption intensity of perylene)+0.0085}/0.1542,
wherein the thickness of the OSP film is not known.

12. The thickness-measuring method according to claim 9, wherein the step of measuring an absorption spectrum of the standard material film is carried out infrared ray spectroscopy.
